(19) United States
(12) Patent Application Publication
(10) Pub. No.: US 2026/0307213 A1
(43) Pub. Date: Oct. 8, 2026

(54) Large Flat Bead Changer

(71) Applicant: Patrick McCarthy, Columbus, OH (US)

(72) Inventor: Patrick McCarthy, Columbus, OH (US)

(21) Appl. No.: 19/171,972

(22) Filed: Apr. 7, 2025

(51) Int. Cl. B25B 9/00; A44C 27/00

(52) U.S. Cl. CPC B25B 9/00; A44C 27/00

(57) ABSTRACT

The Large Flat Bead Changer is a product that body piercers use to attach beads, gems, and other ends on a body piercing. The tip is shaped specifically to hold larger, flat ends inside the silicone tip to allow the piercer to more easily attach the ball or gem to the other part of the jewelry already placed in the client's skin. This design allows you to twist the stick portion of the Large Flat Bead Changer with your thumb and forefinger easily so you can attach beads and ends to jewelry after piercing. This product is especially useful to piercers with long nails or piercers that do not have a stable hand. Without this product, attaching gems and beads is very precise, and the piercer's fingers obstruct vision. With this tool, piercers will be able to streamline the process with a wider variety of gems and beads.

There is no other device like the large flat bead changer used in the Body Piercing Profession. This new product is an extension of our Bead Changer, but larger to accommodate jewelry ends up to 8 mm in size. It is made up of two parts: a silicone tip and a biodegradable stick. The Large Flat Bead Changer is a product that body piercers use to enable them to place beads, gems, and other ends on a body piercing. The tip is shaped specifically to hold larger, flat ends inside the silicone tip to allow the piercer more easily screw or attach the ball or gem to the other part of the jewelry already placed in the client's skin.

The Bead Changer tip was designed to hold a variety of jewelry end sizes between 1.5 mm and 8 mm. The shape of this tip and the softness of the silicon used in the tip allows it to stretch and shrink at the same time allowing a “grip” on the end placed in the tip.

The bead changer works so well because this design allows you to twist the stick portion of the Large Flat Bead Changer with your thumb and forefinger very easily. With this bead changer, it is significantly easier to see the end of the jewelry that the ball or gem is being attached to because your fingers are able to be further away from the ball or gem allowing a clear visual sight to the end it attaches too. This is specifically valuable to piercers that have poor eyesight or shake some. A further advantage of this tool is to make it easier for a person with longer fingernails to perform the task of placing the end on. It is much easier for them to grab the stick rather than trying to grab the bead with longer fingernails.

I designed this product to make it much easier to attach beads and ends to jewelry after being pierced. I'm getting a little older, and my eyesight is not as good as it once was, and my dexterity is not as good. This bead changer makes it so much easier to pierce again and attach the Large Flat Bead Changer beads and ends to the jewelry. The Bead Changer is a unique tool for piercing that is particularly designed to hold gems, beads, and the like to allow for an easier piercing and planning process.

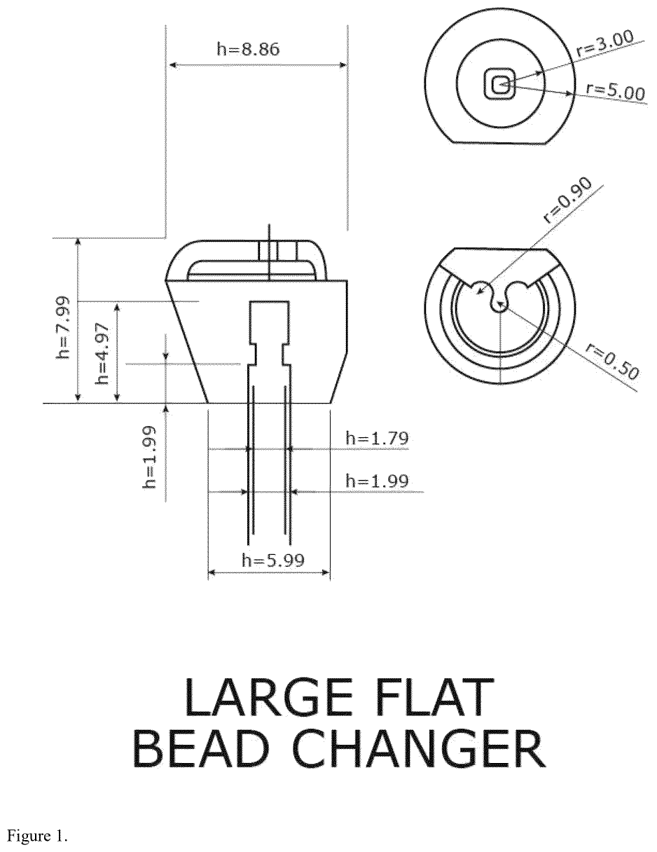

FIG. 1. In reference to the submitted drawing, the Large Flat Bead Changer is made of only two parts. The dimensions of each piece are shown while also demonstrating how they connect to function. The drawing is done on the computer for clarity. It shows the whole product and each piece's dimensions along with a top-down view of the silicone tip. The inside and outside portions are specified within.

FIG. 1 is an overhead view of the product and its two pieces.

1. This device is designed to hold larger, flat ends inside a silicone tip to allow piercers to more easily attach a ball or gem to another part of the jewelry already placed in the client's skin.
